(19) United States
(12) Patent Application Publication
(10) Pub. No.: US 2022/0058734 A1
(43) Pub. Date: Feb. 24, 2022

(54) SYSTEM AND METHOD FOR SECURE ANONYMOUS PAYMENT PROCESSING OF VIRTUAL ASSETS OR SERVICES

(71) Applicant: Mark Walter Vick, Overland Park, KS (US)

(72) Inventor: Mark Walter Vick, Overland Park, KS (US)

(21) Appl. No.: 16/998,229

(22) Filed: Aug. 20, 2020

(51) Int. Cl. G06Q 40/04; G06Q 20/06; G06Q 20/38; G06Q 40/02; G06Q 30/08; G06Q 20/40; G06Q 20/02; H04L 9/08

(52) U.S. Cl. CPC G06Q 40/04; G06Q 20/0655; G06Q 20/383; G06Q 40/02; G06Q 30/08; G06Q 20/405; G06Q 2220/00; G06Q 20/389; G06Q 20/407; G06Q 20/02; G06Q 20/3829; H04L 9/088; G06Q 20/4037

(57) ABSTRACT

A method for secure anonymous payment processing of Services or Virtual Assets. Initially, a Buyer selects an offered Service or Virtual Asset from a Web Site or via a Mobile Application. The Buyer is then challenged to provide a Secondary Factor Authentication to verify the Buyer's identity via a software application such as Google Authenticator, or via a hardware solution such as Yubico or Symantec. Once the Buyer is authenticated, the system allows for the input of the public cryptocurrency addresses. Sellers are similarly authenticated and can add public cryptocurrency addresses, schedules and pricing structures to build offers for sale. The system allows for anonymous order matches between Buyers and Sellers and when a Buyer decides to purchase, the system builds a transaction, comprised of the Buyer and Seller Account Tokens, the dollar amount required to satisfy the Service, or type and quantity of Virtual Assets, including any source and target address information, in the case of a cryptocurrency currency transaction. The System instructs the entity holding the payment, such as a Bank or Debit Card processor, to move the amount of funds required to satisfy the transaction in full plus any fees due to the exchange. The System then notifies the Seller that the Buyer has initiated a transaction and the funds are known-good. The Seller then satisfies the Service or provides the transfer of Virtual Assets as outlined in the transaction. Once the System verifies that the Service or transfer of Virtual Assets is complete, the System instructs the banking entity to move the funds into the Seller's account. In the case of Virtual Assets, the System verifies the movement of the cryptocurrency amount via the publicly available records of the Virtual Asset's Blockchain in real time or via a replicated copy. The transaction is then marked complete, and both parties are satisfied with no chance of fraud occurring on the part of the Buyer or the Seller. If the Service is not performed, or the Virtual Asset is not transferred completely, then the Buyer is refunded in full (when no service was completed or no cryptocurrency asset was transferred at all), or both parties are credited partially (in the case where a calculatable percentage of the service was completed or a percentage of the cryptocurrency asset was transferred) in the proper proportion.

### CROSS-REFERENCE TO RELATED APPLICATIONS

### STATEMENT REGARDING FEDERALLY SPONSORED RESEARCH OR DEVELOPMENT

There were no federal monies used in the research or development of this invention.

### THE NAMES OF THE PARTIES TO A JOINT RESEARCH AGREEMENT

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

### STATEMENT REGARDING PRIOR DISCLOSURES BY THE INVENTOR OR A JOINT INVENTOR

### BACKGROUND OF THE INVENTION

### (1) Field of the Invention

The present invention generally relates to a computer system and method for securely providing a virtual asset exchange that allows for anonymity between the Buyers and Sellers, while providing full bank verified, Know Your Customer verification to all parties involved while decentralizing the movement of the cryptocurrency assets without the system requiring the cryptocurrency private keys. It simultaneously guarantees and verifies both that the transfer of the cryptocurrency assets to the Buyer and ensures that the fiat payment of dollars is made to the Seller, while keeping anonymity between the two parties, if they want to be anonymous, additionally removing any chance of fraud on behalf of either the Buyer or Seller.

### (2) Description of Related Art Including Information Disclosed Under 37 CFR 1.97 and 1.98

### BRIEF SUMMARY OF THE INVENTION

The present invention solves the issue of trust between owners of cryptocurrency assets (Sellers) and the parties with United States dollars (Buyers) that want to make an anonymous transaction. When the two parties are not present in person, neither will trust the other. By introducing this invention which combines a banking partner or processor and by monitoring the associated blockchain of the cryptocurrency being traded, this method allows for both parties to know with full confidence that either 1) the funds will move from Buyer to Seller, and the associated cryptocurrency will move from Seller to the Buyer, or 2) the funds will be refunded in full in the case where no cryptocurrency was transferred within an agreed time limit. In this way, neither party can defraud the other. In the scenario of a partial movement of cryptocurrency, the proportional United States dollars will automatically be credited to both the Buyer and Seller, plus an optional fee to the Seller for completing a transaction incorrectly.

The invention is further described by way of example with reference to the accompanying drawings, wherein:

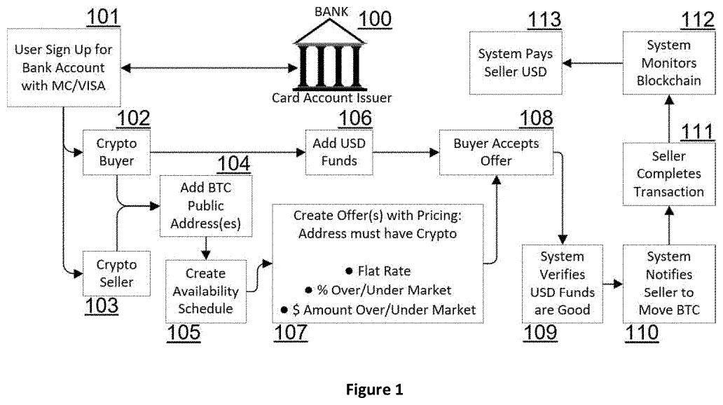

FIG. 1 is a flow chart illustrating modules and steps in the systems and methods of a first preferred embodiment of the system of the invention;

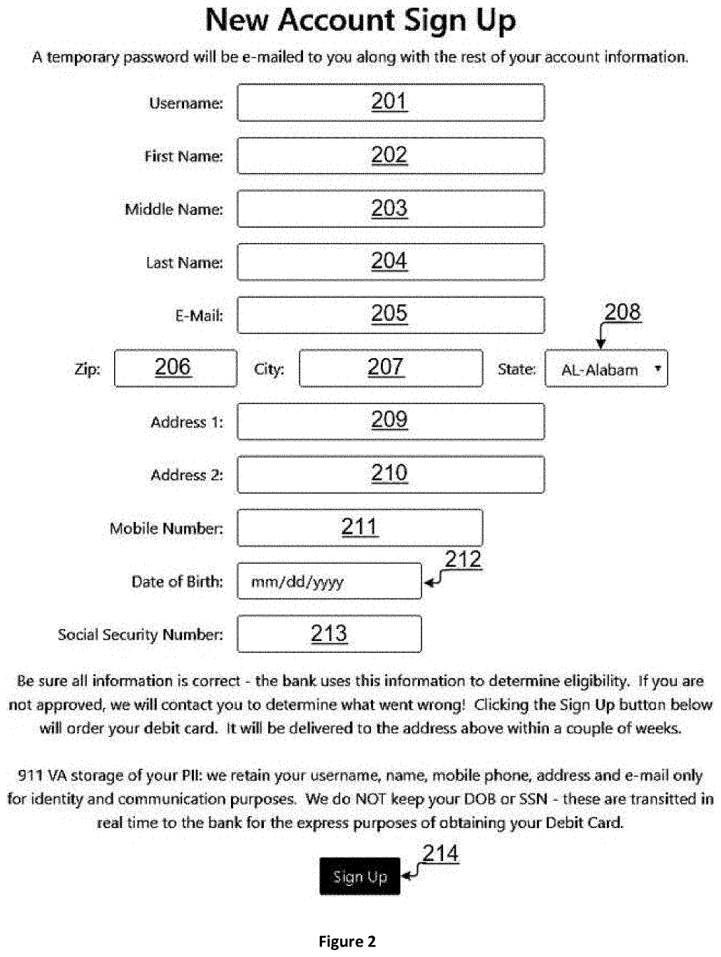

FIG. 2 is a view of a web input page that displays the user interface with fields for signing up a new user;

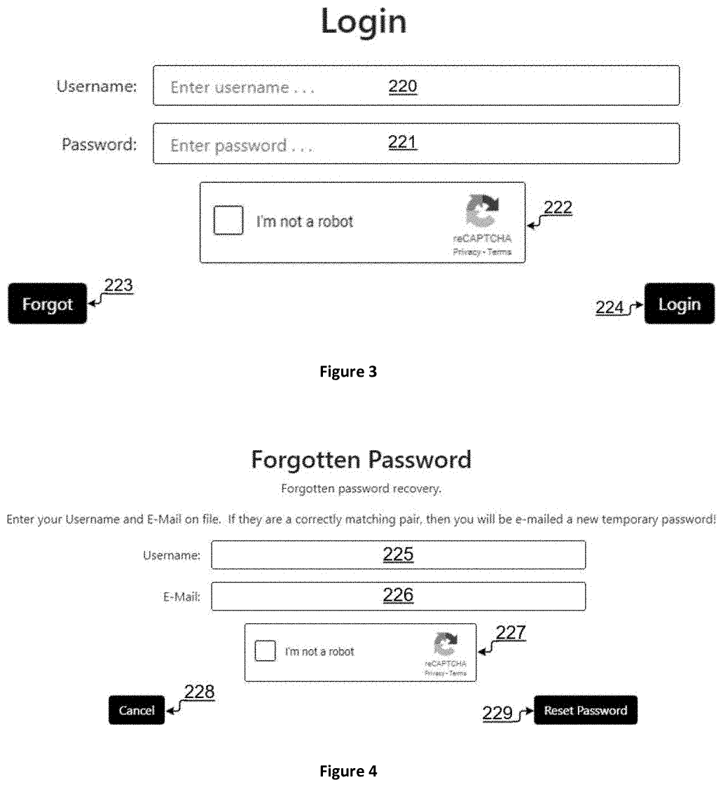

FIG. 3 is a view of a web input page that displays the user interface with fields for entering login credentials;

FIG. 4 is a view of a web input page that displays the user interface with fields for entering forgotten login information;

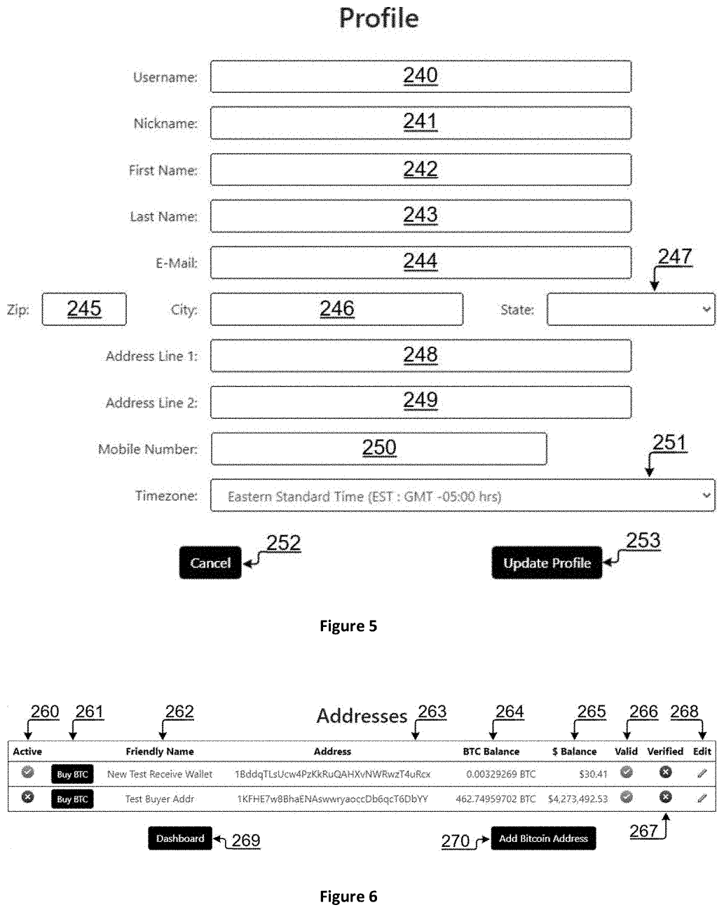

FIG. 5 is a view of a web input page that displays the user interface with fields for updating the user profile;

FIG. 6 is a view of a web page that displays the user interface of the cryptocurrency addresses of the user;

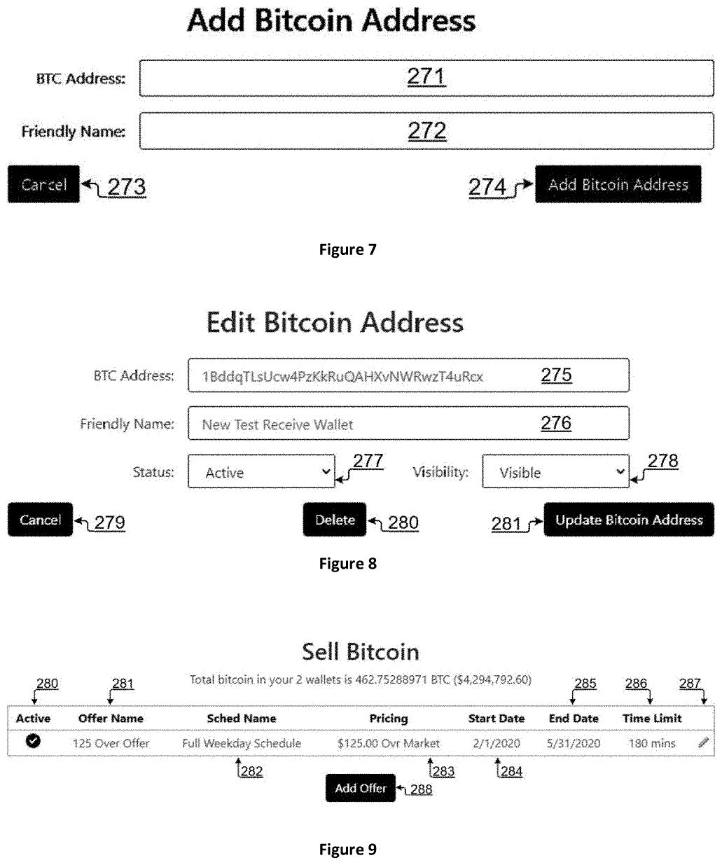

FIG. 7 is a view of a web input page that displays the user interface with fields for entering the cryptocurrency address information;

FIG. 8 is a view of a web input page that displays the user interface with fields for editing the cryptocurrency address information;

FIG. 9 is a view of a web page that displays the user interface of the user's offers for selling cryptocurrency assets;

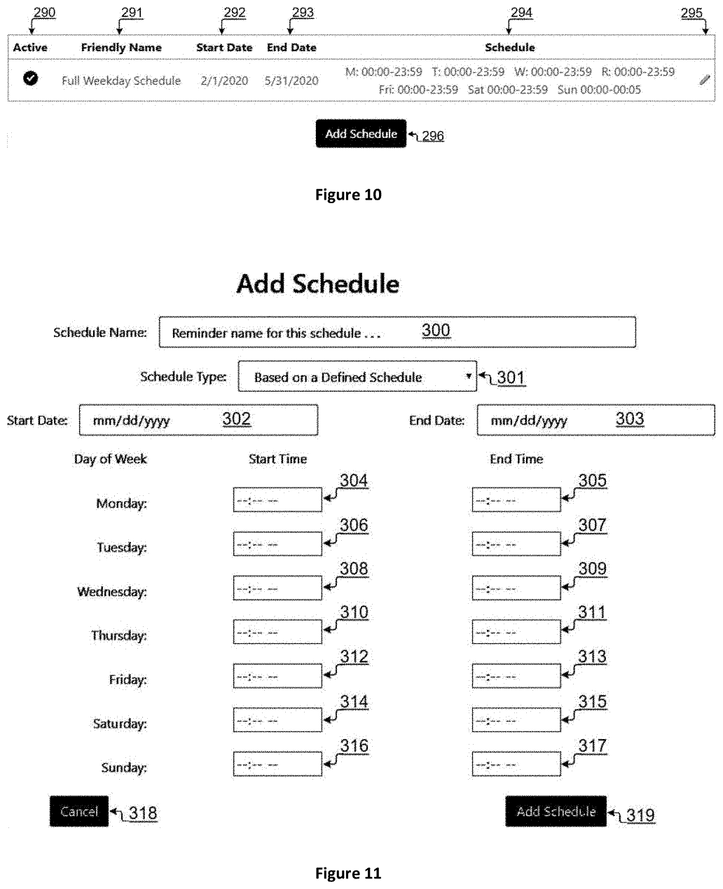

FIG. 10 is a view of a web page that displays the user interface of the schedules of the user;

FIG. 11 is a view of a web input page that displays the user interface with fields for adding a schedule;

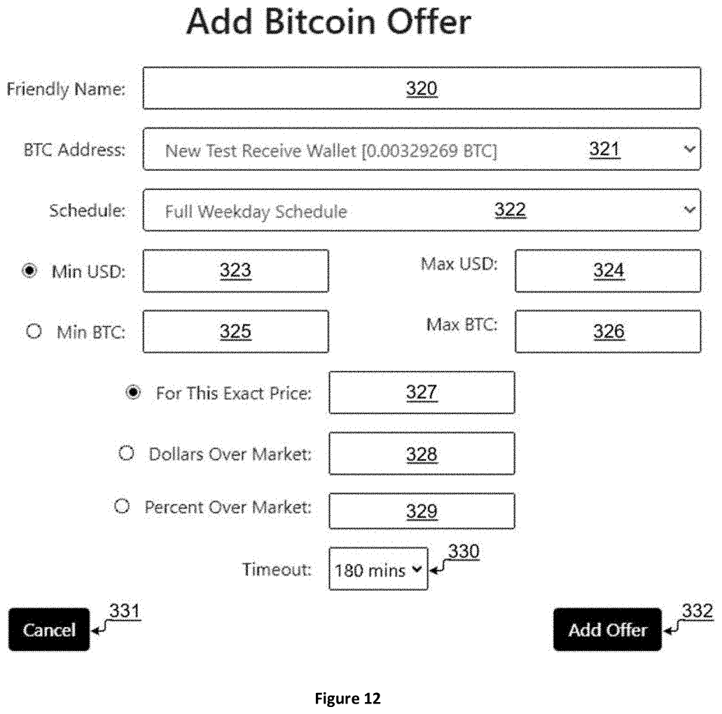

FIG. 12 is a view of a web input page that displays the user interface with fields for adding a cryptocurrency offer;

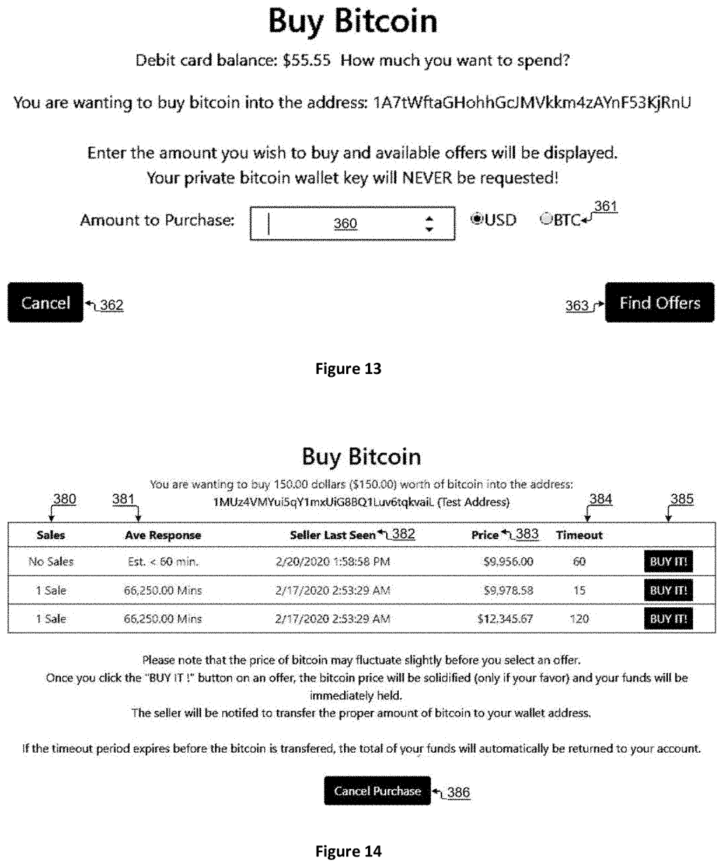

FIG. 13 is a view of a web input page that displays the user interface with fields for part one of buying a cryptocurrency;

FIG. 14 is a view of a web input page that displays the user interface with fields for part two of buying a cryptocurrency by selecting an offer;

### DETAILED DESCRIPTION OF THE INVENTION

FIG. 1 a custom web site 101 to 113 is used to integrate via an optional processor or directly with a Bank 100 to vet new customers, create their financial accounts and issue debit cards. Both the Buyer 102 and the Seller 103 must create accounts and pass industry standard Know Your Customer requirements. Both the Buyer and Seller must register their cryptocurrency addresses 104 on the site before transactions can be initiated. The Seller must also create a Schedule of Availability 105 and an Offer 107, consisting of either 1) a static Flat Rate Price, 2) a Percentage over/under the current cryptocurrency market or 3) a set dollar amount over/under the current cryptocurrency market. Before making a purchase, a Buyer must deposit funds 106 in United States dollars. When the Buyer makes a purchase, they enter a dollar or cryptocurrency amount and are presented with a listing of matching offers, finally accepting one of the available Offers 108 currently active in the system. The system verifies that funds are good 109 by checking the Buyer's balance in real-time directly with the bank or via a processor. The system then notifies the Seller 110 to move the appropriate amount of cryptocurrency and from and to which cryptocurrency addresses. The Seller then completes the transaction 111 by transferring the correct cryptocurrency amount from their source address to the Buyer's target address. The system monitors the appropriate public blockchain for the transaction 112 in real time, or via a replicated blockchain ledger, and upon finding a matching transaction, instructs the bank or processor to pay the Seller 113 into their account. If the cryptocurrency transaction is not initiated within the specified amount of time, then the system refunds the dollars back to the Buyer 113.

Using a device containing a web browser a user navigates to the web address containing the code for FIG. 2. In order to create an account, each user must create a unique username 201, and then enter their first name 202, middle name 203, last name 204, their e-mail address 205, and full current physical address consisting of the zip code 206, city 207, state 208, address line 1209, address line 2 210. Additionally the user's mobile phone number 211, date of birth 212, and social security number 213 is collected and transferred upon selection of the Sign Up button 214 either directly, or via a processor, to the banking partner in order to verify, authenticate and satisfy the Know Your Customer rules to establish a banking account and issue a unique debit card to the user.

To log into the web site, a user navigates to the web address containing the code for FIG. 3. The user enters their username 220 and password 221, as well as validate the captcha 222 before selecting the Login button 224. When a user has forgotten their credentials, they select the Forgot button 223 which takes them to the Forgotten Password FIG. 4 web page. On the Forgotten Password FIG. 4 web interface a user can enter their username 225 or e-mail address 226 as well as validate the captcha 227 before selecting the Reset Password button 229. If the username or e-mail matches a valid user account in the system, the user account is assigned a new, randomly generated password and an e-mail is sent to the e-mail address on file with that newly generated password. The users can also exit from this web interface by pressing the Cancel button 228.

An authenticated user can view their Profile FIG. 5. Because they have passed the banking Know Your Customer process, most fields are read-only: Username 240, First Name 242, Last Name 243, E-Mail 244, Zip 245, City 246, State 247, Address Line 1 248, Address Line 2 249 and Mobile Number 250. The Nickname 241 field is editable, provided that the new value has not already been used by another User. The Time Zone 251 is a required selection before buying or selling can be initiated, so that the correct timing between the schedules on offers can be factored into the local time zones of both the Buyers and Sellers. The user can decide not to save any updated field values on this web interface by selecting the Cancel button 252, or the user can save all changes by selecting the Update Profile button 253.

Whether the user intends to buy or sell cryptocurrency assets on the site, they must enter the addresses of the cryptocurrency assets they intend to use. These are listed in FIG. 6. The user can add an address by selecting the Add Bitcoin Address button 270 which takes the user to FIG. 7 where the user enters the cryptocurrency Address 271, a Friendly Name 272 and then selects the Add Bitcoin Address button 274. On this page, the user can also cancel the address addition by selecting the Cancel button 273.

The Address listing FIG. 6 displays the attributes of the users' cryptocurrency addresses in tabular format. Each row displays an icon denoting whether or not the given address is currently Active 260. When the address is Active and Valid, there is a Buy BTC button 261. Next, the Friendly Name 262, followed by the cryptocurrency address 263. The current cryptocurrency balance 264 is followed by a calculated USD Value 265. An icon indicator showing whether or not the address is Valid 266 is followed by an icon indicator showing the address is Verified 267 after the address has been used successfully in a sale transaction by a Seller.

From the Addresses listing FIG. 6, the user can edit an existing address by selecting the appropriate row's Edit icon 268 which navigates the web browser to FIG. 8 to Edit an Address. The user cannot update the cryptocurrency Address 275, but the Friendly Name 276 can be updated. If the user wants to change the Status 277 or Visibility 278, these selections can also be made here. The user can select the Cancel button 279, remove the address from the site with the Delete button 280, or save all changes by selecting the Update Bitcoin Address 281 button.

In order to make an Offer to sell cryptocurrency assets, a Seller must first create at least one Schedule FIG. 10 that will denote the available times during which they will be available to satisfy accepted offers within a reasonable timeframe. The user selects the Add Schedule button 296 to go to FIG. 11 where the user enters the Schedule Name 300, then selects a Schedule Type 301. Depending on whether the Schedule Type is “Based on When I am Active” or “Based on a Defined Schedule” the user must enter a Start Date 302 and an End Date 303 to denote the date range that the schedule will be active. If the user selects “Based on a Defined Schedule” then they must also enter daily start and end times by entering the hour and minutes beginning with Monday Start 304 and End 305, Tuesday Start 306 and End 307, Wednesday Start 308 and End 309, Thursday Start 310 and End 311, Friday Start 312 and End 313, Saturday Start 314 and End 315 and Sunday Start 316 and End 317. The user has the option to Cancel changes with the Cancel button 318 or they can add the Schedule with the Add Schedule button 319.

All users' Schedules FIG. 10 are displayed in tabular format. Each row displays an icon denoting whether or not the Schedule is currently Active 290, followed by its Friendly Name 291. If the user sets up a Start 292 and End 293 date range, then those values are displayed next, along with the detailed hourly schedule covering each day of the week 294. The final column allows for the Schedule to be Edited 295 by selecting the row's icon. A new Schedule can also be added here by pressing the Add Schedule button 296.

After a Schedule has been created, and is active, the Seller creates an Offer FIG. 12 which sets the financial parameters that the Seller requires to accept an offer. To add an Offer FIG. 12 the user must specify a unique Friendly Name 320, select one of their active cryptocurrency Addresses 321 and an active Schedule 322. Then either the United States dollar Minimum 323 to Maximum 324 range or the cryptocurrency currency Minimum 325 to Maximum 326 sale quantity range is denoted. Actual values are determined based on the current market price when the offer is accepted. Finally, the Seller's requested price is entered by selecting one of Exact Price 327, Dollars over Market 328 or Percent over Market 329 and the Timeout 330 which specifies the number of minutes after acceptance within which the Seller agrees to satisfy their side of the transaction by transferring the cryptocurrency asset to the correct Buyer's target cryptocurrency address. The user can cancel the creation of the bitcoin offer by selecting the Cancel button 331, or complete the bitcoin offer by selecting the Add Offer button 332.

An Offers Listing FIG. 9 displays full details on the user's existing offers in tabular format containing an icon denoting whether or not the Offer is currently Active 280, the current Friendly Name 281, the offer's Schedule Name 282, the Pricing Format 283, its Start Date 284, End Date 285, and the Time Limit 286. On each row, a button exits to allow the Offer to be edited 287 by selecting the row's icon. The Add Offer button 288 allows the user to add a new offer to the system.

From the Buy BTC button 261 on FIG. 6 the user is presented with a display FIG. 13 that shows their current account balance in dollars and the cryptocurrency address that they wish to be the target of this purchase. They must enter an amount 360 to transact, and whether that amount represents United States dollars or a cryptocurrency quantity 361 to buy. They can either press the Cancel button 362 or search for available offers by pressing the Find Offers button 363.

The Find Offers button 363 displays all available matching Offers FIG. 14 in the system in ascending order based on cryptocurrency price. The complete details of the transaction are displayed including the amount in dollars and the target address. In tabular format, available matching Offers are displayed with some Seller attributes to help the Buyer decide with whom to transact. The number of Sales 380, the Seller's average response time 381 and when the Seller was last seen 382 on the web site. The Price 383 and timeout period selected 384 are also shown. To initiate a transaction the Buyer selects the Buy It! Button 385 on the appropriate row. If the user wishes to cancel the purchase, they can press the Cancel button 386.

In an alternate revision, the current offer's price is displayed and the Find Offers button 363 has its text changed to Buy Now and the transaction is immediately completed from a specific cryptocurrency address owned whose private key is controlled by a White Label partner that has been signing up users into a closed loop. In this scenario, the users can only buy and sell to the White Label entity. Depending on the needs of the White Label partner, the system may additionally control the private key of this source address, to automate the completion of the transactions, or the White Label partner may want to manually complete the transactions, in which the system still does not control any private cryptocurrency keys.

1. The invention claimed is a method of secure, remote, anonymous transaction of cryptocurrency assets without allowing the chance by either party, the Seller or Buyer, to defraud the other party without having to meet in person to exchange dollars, by comprising: the registering of users via a host computer system web interface to a bank or processor following traditional Know Your Customer requirements and creating an account and subsequently issuing a debit card to each user; an electronic database containing user profile information, login, second factor authentication information, bank account tokens and public cryptocurrency addresses; allowing for the creation of optional schedules during which sellers will make themselves available to transfer cryptocurrency assets to complete transactions; creating matches between sell offers and Buyers based on price, available cryptocurrency balances or minimum and maximum transaction sizes, displaying performance indicators and total transactions on a per Seller basis, while maintaining anonymity when the Sellers desire anonymity; upon acceptance of an offer by a Buyer, verifying that sufficient source dollar funds exist, request the processor or bank to move the funds; notifying the Seller via text messaging and/or electronic mail that transaction funds are known-good, supplying the details of the transaction, such as source and target addresses, amount in dollars and cryptocurrency to be transacted and the time limit within the cryptocurrency transfer must take place to both the Buyer and Seller; monitoring the associated blockchain in real-time or via a replicated copy to determine that the transfer did, in fact, take place, and in the case that the transaction was correctly and fully satisfied, direct the bank or processor to credit the Seller; when the Seller does not satisfy the sale at all, the system refunds the Buyer in full; in the case of partial satisfaction, the Buyer shall be reimbursed at the same percentage, while the Seller will be paid in the percentage that they did transact, minus an optional fee for incorrectly completing a transaction and the system shall track the dates and numbers of these; the system does not require the private keys for any cryptocurrency addresses—all users retain full control over their own addresses at all times; the system does not hold or control any of the dollar assets, the bank controls these funds and merely moves funds on request directly from the system or via a processor via the visa or mastercard network, or directly between user accounts at the bank.

2. The method of claim 1, further comprising of a closed network of Buyers from a single Seller entity, or a “closed network” whereby the Seller garners its own client Buyers, by having them sign up for an account on a White Labeled system, so that all sales go through the single Seller's address; no matching between individual Buyers and Sellers is done; each Buyer buys from the same White Labeled, closed network at the agreed to terms and if they optionally sell cryptocurrency back to the Seller, the sale goes only to the closed network, not to other users of the same system; the system shall optionally control the private key of the White Labeled entity and automatically transact these sales on their behalf.
